(19) United States
(12) Patent Application Publication
(10) Pub. No.: US 2011/0062632 A1
(43) Pub. Date: Mar. 17, 2011

(54) TEMPLATE WITH IDENTIFICATION MARK AND METHOD OF MANUFACTURING THE SAME

(76) Inventor: Masato SAITO, Machida-shi (JP)

(21) Appl. No.: 12/883,969

(22) Filed: Sep. 16, 2010

(30) Foreign Application Priority Data
Sep. 16, 2009 (JP) 2009-214810

(51) Int. Cl. B29C 59/16; B29C 35/08

(52) U.S. Cl. 264/400; 425/385

(57) ABSTRACT

According to one embodiment, a template with an identification mark for use in SFIL includes a pattern formation template including a main pattern region where a desired pattern is formed as a convex/concave pattern on the upper surface of a light-transmitting substrate, and an identification mark that is formed on the lower surface of the substrate to partially overlap the main pattern region, and makes the template identifiable.

### CROSS-REFERENCE TO RELATED APPLICATIONS

This application is based upon and claims the benefit of priority from Japanese Patent Application No. 2009-214810, filed Sep. 16, 2009; the entire contents of which are incorporated herein by reference.

### FIELD

Embodiments described herein relate generally to a template with an identification mark to be used when forming patterns by using step and flash imprint lithography (SFIL), and a method of manufacturing the same.

### BACKGROUND

Recently, SFIL is attracting attention as a pattern transfer technique of micropatterning semiconductor integrated circuits. SFIL is sometimes unable to perform accurate pattern transfer due to, e.g., wear corresponding to the use frequency, clogging of pattern recesses, and breakage. Therefore, a general procedure is to prepare a plurality of templates having the same shape, and switch templates in accordance with a defined number of times of use, or the occurrence of transfer defects.

In a method using electron-beam lithography in the manufacture of templates, however, a very long writing time is necessary to manufacture only one template.

Accordingly, a general approach is to prepare a plurality of templates having the same shape by manufacturing a plurality of child templates by imprinting by using a template manufactured by electron-beam lithography as a parent template, and form patterns on a substrate by using the child template.

On the other hand, in the manufacturing process of forming patterns by using SFIL, a certain unique mark that makes a template to be used identifiable is desirably given to the template in order to manage the type, log, and the like of the template. In a method of marking an ID by additionally processing a template after it is manufactured, however, dust produced during the additional processing may adhere on patterns, or the work of the additional processing itself may damage patterns on the template.

### BRIEF DESCRIPTION OF THE DRAWINGS

FIG. 1 is a perspective view showing an outline of the arrangement of a template with an identification mark according to the first embodiment;

FIG. 2 is a sectional view taken along a line A-A′ in FIG. 1, which explains the outline of the arrangement of the template with an identification mark according to the first embodiment;

FIG. 3 is a plan view showing the outline of the arrangement of the template with an identification mark according to the first embodiment;

FIG. 4 is a sectional view showing the structure of a processing stage for additionally processing the template;

FIG. 5 is a plan view showing the structure of the processing stage for additionally processing the template;

FIG. 6 is a sectional view showing the way the template is additionally processed by using a laser processor;

FIGS. 7A, 7B, and 7C are sectional views showing the shapes of engraved patterns;

FIGS. 8A, 8B, 8C, and 8D are sectional views showing pattern transfer steps using SFIL;

FIGS. 9A, 9B, 9C, 9D, and 9E are sectional views showing steps of manufacturing a pattern formation template by using electron-beam lithography; and

FIG. 10 is a plan view showing an outline of the arrangement of a template with an identification mark according to the second embodiment.

### DETAILED DESCRIPTION

In general, according to one embodiment, a template with an identification mark for use in SFIL includes a pattern formation template including a main pattern region where a desired pattern is formed as a convex/concave pattern on the upper surface of a light-transmitting substrate, and an identification mark that is formed on the lower surface of the substrate to partially overlap the main pattern region, and makes the template identifiable.

The embodiments will be explained below with reference to the accompanying drawing.

### First Embodiment

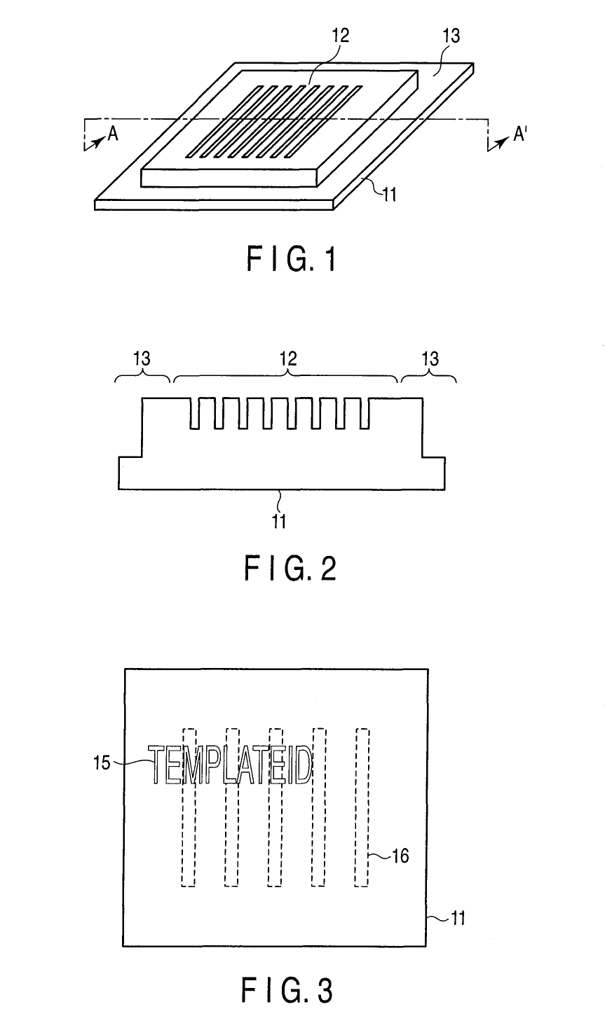

FIG. 1, FIG. 2, and FIG. 3 are views for explaining an outline of the arrangement of a template with an identification mark according to the first embodiment. FIG. 1 is a perspective view, FIG. 2 is a sectional view taken along a line A-A′ in FIG. 1, and FIG. 3 is a plan view in which the template is viewed from the lower surface.

As shown in FIG. 1 and FIG. 2, the surface of a substrate 11 made of a light-transmitting material such as quartz is divided into a main pattern region 12 for forming a desired pattern, and a peripheral region 13 surrounding the main pattern region 12. In the main pattern region 12, a desired pattern such as an LSI pattern is formed as a convex/concave pattern. A portion of the peripheral region 13 is entirely etched to make the surface lower than the main pattern region 12. Note that it is not always necessary to make a portion of the peripheral region 13 lower than the main pattern region 12, and the whole peripheral region 13 may have the same height as that of the main pattern region 12.

As shown in FIG. 3, a unique identification mark 15 for identifying the type, log, and the like of a template is formed on the lower surface of the substrate 11. The mark 15 is, e.g., a character string, and formed by partially engraving the lower surface of the substrate 11. Also, the mark 15 is formed in a position interfering with the main pattern region 12, i.e., in a region partially overlapping the main pattern region 12. Note that reference numeral 16 in FIG. 3 indicates a transmitted image of the pattern formed on the upper surface of the template.

A method of manufacturing the template with an identification mark according to the first embodiment will be explained below.

In the first embodiment, after a pattern formation template for use in SFIL is manufactured, an identification mark that makes the template identifiable is marked on the lower surface of the template by using a laser processor. More specifically, the identification mark is formed in a region including a part of or the whole region where a projected pattern exists on the lower surface side when viewed from the upper surface side on which the pattern is formed on the template.

Note that the existing techniques are used as a method of manufacturing the pattern formation template and a pattern formation method using SFIL, and these methods will be described later.

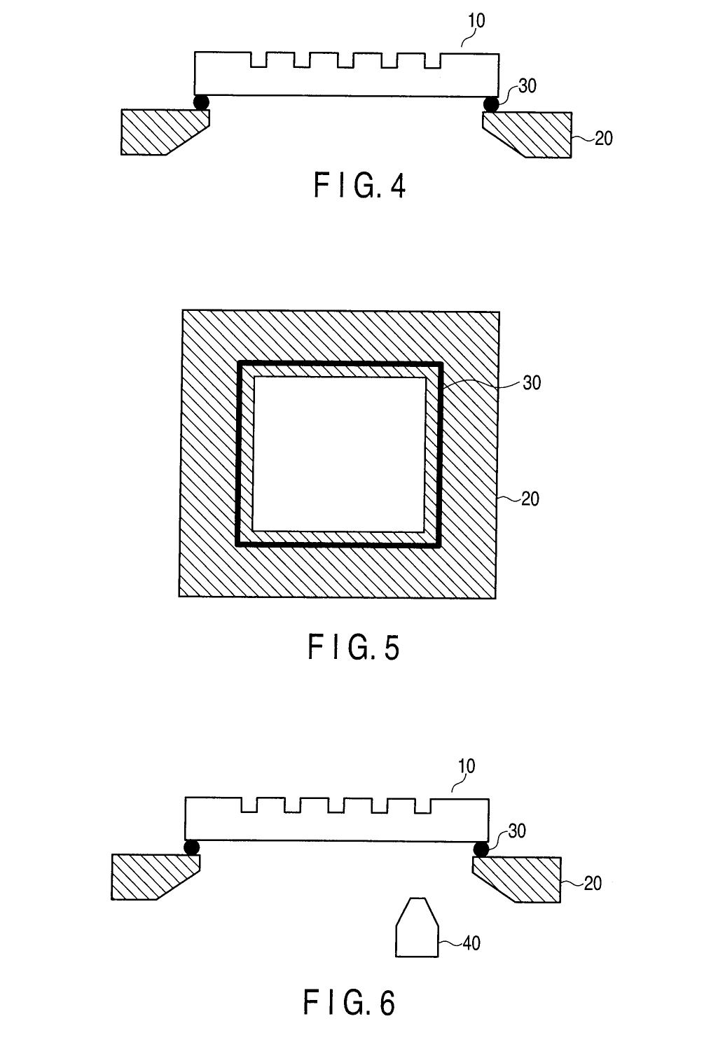

First, a pattern formation template on which a desired pattern is formed is prepared. Then, as shown in FIG. 4, a template 10 is held on a processing stage 20 with the pattern formation surface facing up. That is, the template 10 is placed on the processing stage 20 having an opening slightly smaller than the template 10 with the lower surface of the template 10 facing down. Note that a holding jig 30 is brought into contact with only the lower surface side when viewed from the pattern formation surface of the template 10.

Note also that an O-ring is formed as the template holding jig 30 on the surface of the processing stage 20 so as to airtightly seal the opening of the processing stage 20 with the template 10 being placed on it. That is, it is desirable to adjust the shape and function of the holding jig 30 so that the template lower surface as a surface to be processed and the template upper surface on which the pattern exists are isolated as much as possible.

For example, the holding jig 30 shown in FIG. 5 has a shape obtained by forming a highly elastic resin having no air permeability into a rectangular ring slightly smaller than the outer circumference of the template 10, and the template 10 to be additionally processed is placed on the holding jig 30 with the lower surface of the template 10 facing down. Accordingly, the holding jig 30 is brought into tight contact with the template 10 by its own weight, and improves the isolation between the upper and lower surfaces of the template 10.

After the template 10 is held on the processing stage 20 as described above, as shown in FIG. 6, the lower surface side of the substrate 11 of the template 10 is irradiated with laser light by using a laser processor 40, thereby selectively processing the surface shape of the lower surface of the substrate 11. In this manner, the identification mark 15 that makes the template 10 identifiable is formed.

In this embodiment, the mark 15 is formed by engraving the lower surface of the substrate 11 by the laser light. In this process, the bottom of the engraved portion is desirably processed to have a surface roughness with which the light transmittance of a mark portion formed by the engraving and that of a non-mark portion are almost the same. The “light” herein mentioned is the same as light to be emitted to cure a photocurable resin when forming a pattern by SFIL by using the template 10.

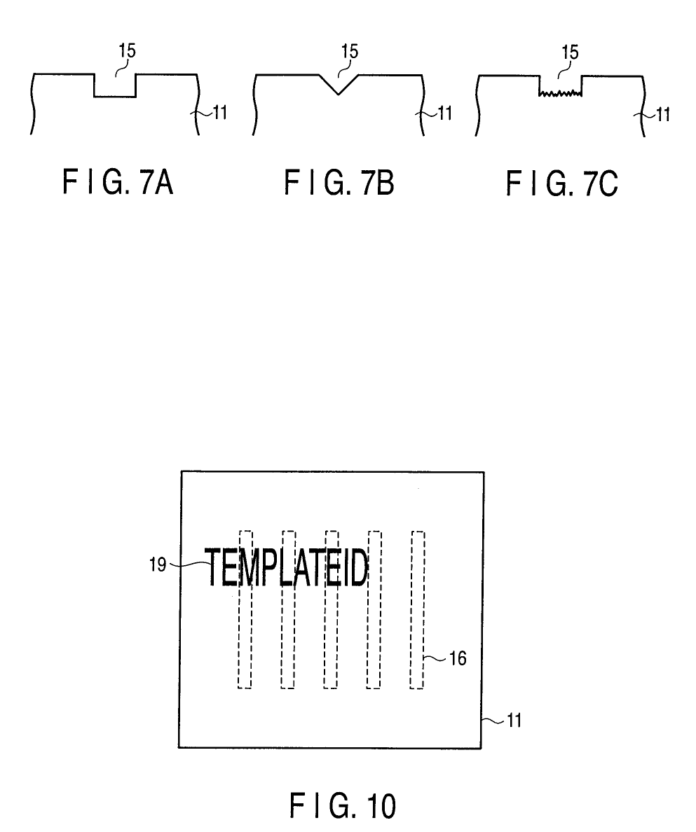

More specifically, as shown in FIG. 7A, to avoid unwanted scattering and attenuation, the processed side surfaces are desirably vertical, and the processed bottom surface is desirably parallel to the upper surface. This is so because if the side surfaces incline as shown in FIG. 7B, or if the bottom surface is roughened as shown in FIG. 7C, light to be used in SFIL is irregularly reflected or scattered, so the existence of the mark 15 exerts an adverse effect on the pattern.

Next, the position of the mark 15 that is formed by the additional processing and makes the template 10 identifiable will be explained. The mark 15 formed by the additional processing is generally transparent to the irradiating light for curing the photocurable resin, which is used in the pattern formation step using SFIL. Therefore, the existence of the mark 15 does not obstruct the curing of the photocurable resin. Accordingly, the position of the mark 15 may interfere with the main pattern region where the pattern to be transferred is formed. As shown in FIG. 3, therefore, the identification mark 15 is formed by the additional processing so that a part of or the whole mark 15 is included in a region (on the lower surface) corresponding to the region where the transfer target pattern is formed on the template upper surface.

When a pattern is formed on a substrate by SFIL using the template with an identification mark on which the mark 15 capable of identification is formed, the pattern on the template 10 can be formed on a desired substrate without any influence of the mark formed by the additional processing. Since the identification mark 15 can be given with a sufficient space being secured, detailed management of the template 10 is possible.

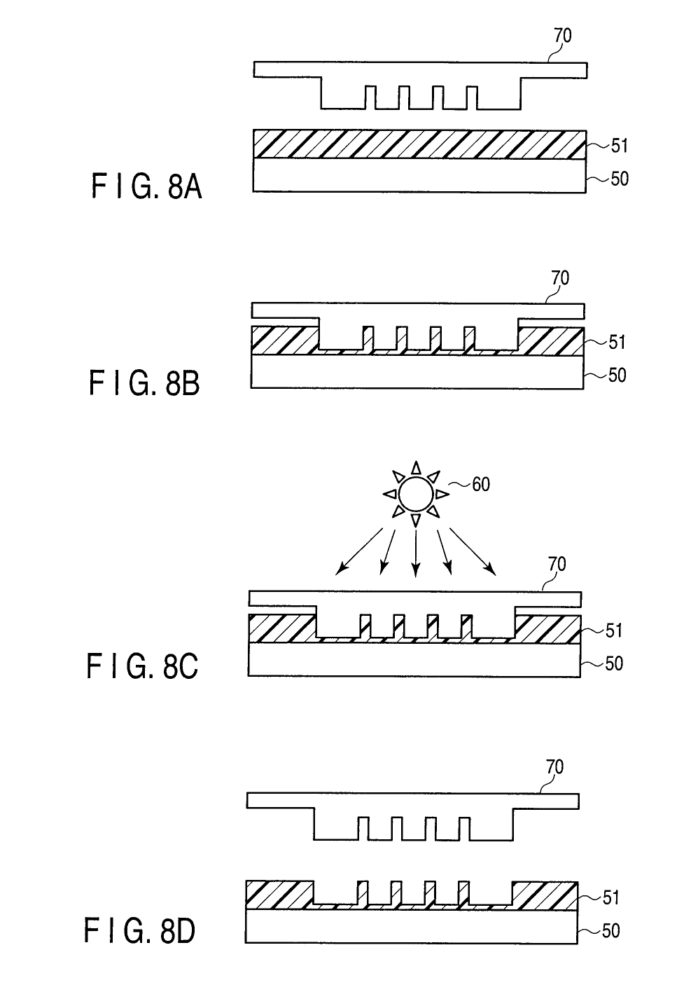

An example of SFIL using the template with an identification mark will be explained below. FIGS. 8A, 8B, 8C, and 8D illustrate an example of the procedure of a pattern formation method using SFIL.

First, as shown in FIG. 8A, a semiconductor substrate 50 as a target of pattern processing is coated with a photocurable resin composition 51. Subsequently, a necessary template 70 is selected by checking the identification mark 15 from among a plurality of prepared templates 70 with identification marks. As shown in FIG. 8B, the selected template 70 is pushed against the photocurable resin composition 51. The substrate is left to stand in this state until the photocurable resin 51 fills recesses of the template 10 by capillary phenomenon.

Then, as shown in FIG. 8C, the lower surface side of the template 70 is irradiated with light (e.g., an i line of 365 nm) emitted from a light source 60, thereby curing the photocurable resin composition 51. Finally, as shown in FIG. 8D, the template 70 is separated from the substrate 50. Consequently, a pattern is formed by the cured resin on the substrate 50 such that projections and recesses are inverted from those of the pattern formed on the template 70. A pattern can be formed on the substrate 50 by performing processing such as etching by using the pattern of the resin composition 51 as a mask.

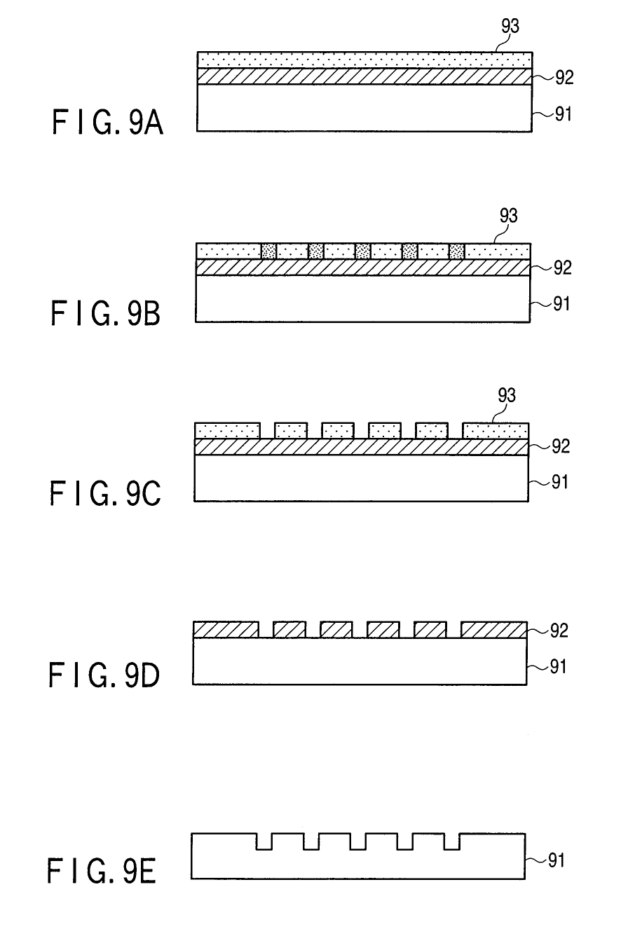

An example of a method of manufacturing a pattern formation template by using electron-beam lithography will be explained below. FIGS. 9A, 9B, 9C, 9D, and 9E illustrate an example of the procedure of manufacturing a pattern formation template for use in SFIL.

First, as shown in FIG. 9A, a template substrate 91 for manufacturing a template is prepared. Synthetic quartz is generally used as the material of the template substrate 91. This is so because the photocurable resin is cured by irradiating the pattern lower surface with light in the photocurable resin curing step, so the material must be transparent to the irradiating light. Subsequently, a Cr film 92 is formed on the surface of the template substrate 91 by sputtering, and the surface of the Cr film 92 is coated with a resist 93 sensitive to an electron beam.

Then, as shown in FIG. 9B, an electron-beam exposure apparatus is used to write a desired pattern on the prepared template substrate 91, and selectively expose the resist 93 as a template substrate surface layer to light. As shown in FIG. 9C, the template substrate 91 having undergone the writing process is developed, and the resist 93 is removed from the portions exposed to the electron beam, thereby forming a resist pattern.

Subsequently, as shown in FIG. 9D, the Cr film 92 is etched by, e.g., RIE (Reactive Ion Etching) by using the pattern of the resist 93 as a mask, and the remaining resist 93 is removed by a separating process.

As shown in FIG. 9E, the quartz substrate 91 is engraved to a desired depth by, e.g., RIE by using the patterned Cr film 92 as a mask. After that, the Cr film 92 on the surface is removed, thereby manufacturing a pattern formation template 90 having the desired pattern formed into a convex/concave pattern on the template substrate 91.

The above-mentioned pattern formation procedure using SFIL is performed by using the pattern formation template 90 manufactured following the procedure as described above. Consequently, the pattern formed on the template 90 is transferred onto a desired substrate by the cured photocurable resin with projections and recesses of the pattern being inverted. After that, processing such as etching is performed on the substrate by using the photocurable resin pattern formed on the substrate as a mask. This makes it possible to form the desired pattern on the substrate without any influence of the identification mark 15 formed by additional processing.

The template manufacturing method using electron-beam lithography disclosed in the above-mentioned template manufacturing procedure requires a very long writing time to write a pattern by using an electron beam. For example, a writing time of about a month is required to write a pattern in which a 65 mm×65 mm region is filled with lines and spaces at a half pitch of 20 nm, by using a presently widely used Gaussian-beam lithography apparatus having an acceleration voltage of 100 keV.

In this embodiment, therefore, after the template 90 is manufactured by electron-beam lithography, the template 90 is used as a parent template to manufacture a plurality of child templates by the imprinting method as shown in FIGS. 8A, 8B, 8C, and 8D, or a plurality of grandchild templates are further manufactured from the child templates, thereby preparing a plurality of templates 10 having the same shape. A pattern is formed on a substrate by using the child template or grandchild template.

The formation of the above-mentioned identification mark 15 is effective in manufacturing a large number of templates 10 as described above. That is, after the template 10 to be used in SFIL is manufactured, the manufactured template 10 is additionally processed to form the identification mark 15 that makes the template 10 identifiable, on a surface other than the pattern formation surface. Since the surface other than the pattern surface is additionally processed, it is possible to minimize the risk that the additional processing inflicts damage to the pattern portion. Also, pattern processing by imprinting is not affected even when the mark 15 is formed in a position that three-dimensionally interferes with the pattern position. This makes it possible to increase the degrees of freedom of the mark position and mark size.

In this embodiment as described above, the pattern formation template 10 can be identified regardless of whether it is a child template or grandchild template, without inflicting any damage to the pattern formed on the template 10. This facilitates production management. In addition, since the formation region of the identification mark 15 is wider than that in the conventional method, the template 10 can be given more information than that in the conventional method. This makes the management more detailed than that in the conventional method.

### Second Embodiment

FIG. 10 is a plan view showing an outline of the arrangement of a template with an identification mark according to the second embodiment. Note that the same reference numerals as in FIG. 3 denote the same parts, and a repetitive explanation will be omitted.

The second embodiment is directed to a method by which a template 10 for use in SFIL is manufactured, and a mark 19 that makes the template 10 identifiable is formed by using paint on the lower surface side when viewed from the pattern formation side of the template 10. Note that the existing technique is used as a method of manufacturing the pattern formation template 10, and a detailed description of the method will be omitted in this embodiment.

First, the pattern formation template 10 on which a desired pattern is formed is prepared. Then, the template 10 is held on a processing stage 20 as shown in FIG. 4 with the pattern formation surface facing up. The structure of the processing stage 20 and the method of placing the template 10 on the processing stage 20 are the same as in the first embodiment, and a repetitive explanation will be omitted. The mark 19 that makes the template 10 identifiable is formed by using paint on the lower surface of the template 10 placed on the processing stage 20. As the method of forming the mark 19 by paint, it is possible to use, e.g., a pattern formation method performed by inkjet paint coating extensively used in printing methods.

The paint to be used is desirably paint that generally transmits the wavelength of light emitted to cure the photocurable resin when performing pattern transfer by SFIL.

When using the paint having the feature as described above, the existence of the mark 19 dose not obstruct the curing of the photocurable resin when performing pattern transfer by SFIL. Therefore, the position of the mark 19 may interfere with a region where a pattern to be transferred exists. Accordingly, the mark 19 can be formed by additional processing in a region where a part of or the whole mark 19 is included in a region where a pattern to be transferred is formed on the template surface. It is also possible to select a position where no region to be transferred is formed on the template surface, and form the mark 19 by additional processing.

In this embodiment as described above, when forming a pattern on a substrate by SFIL by using the template 10 on which the mark 19 capable of identification is formed, the pattern on the template 10 can be formed on a desired substrate without any influence of the mark 19 formed by additional processing. Therefore, the same effects as those of the first embodiment described previously can be obtained.

### (Modifications)

Note that the present invention is not limited to each embodiment described above. Although quartz is used as the template substrate in each embodiment, the template substrate is not necessarily limited to quartz, and it is possible to use any material having a sufficient transmittance to the wavelength of light to be used in SFIL.

The identification mark is not limited to an arbitrary character string. The identification mark may be a one-dimensional barcode mark or two-dimensional barcode mark, and can also be formed by combining them. Also, the depth of grooves formed as the identification mark by engraving a substrate may appropriately be determined in accordance with the specifications. Furthermore, the paint to be used as the identification mark need only be paint that has a sufficient transmittance to the wavelength of light to be used in SFIL, and one that does not obstruct the curing of the photocurable resin.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A template with an identification mark, comprising:
a pattern formation template to be used in step and flash imprint lithography, the template including a main pattern region where a desired pattern is formed as a convex/concave pattern on an upper surface of a light-transmitting substrate; and
an identification mark which is formed on a lower surface of the substrate and makes the template identifiable, the mark being formed to partially overlap the main pattern region.

2. The template according to claim 1, wherein the identification mark is formed by one of an arbitrary character string, a one-dimensional barcode mark, a two-dimensional barcode mark, and a combination of arbitrary character string, the one-dimensional barcode mark, and the two-dimensional barcode mark.

3. The template according to claim 1, wherein the identification mark is formed by engraving the lower surface of the substrate.

4. The template according to claim 3, wherein the identification mark formed by engraving the lower surface of the substrate includes a vertical side surface and a flat bottom surface.

5. The template according to claim 1, wherein the identification mark is formed by coating the lower surface of the substrate with paint, and the paint has transparency which does not obstruct curing of a photocurable resin, with respect to a wavelength of irradiating light to be used when curing the photocurable resin by step and flash imprint lithography.

6. A template with an identification mark, comprising:
a pattern formation template to be used in step and flash imprint lithography, the template including a main pattern region where a desired pattern is formed as a convex/concave pattern on an upper surface of a light-transmitting substrate; and
an identification mark which is formed on a lower surface of the substrate and makes the template identifiable, the mark being formed to entirely overlap the main pattern region.

7. The template according to claim 6, wherein the identification mark is formed by one of an arbitrary character string, a one-dimensional barcode mark, a two-dimensional barcode mark, and a combination of arbitrary character string, the one-dimensional barcode mark, and the two-dimensional barcode mark.

8. The template according to claim 6, wherein the identification mark is formed by engraving the lower surface of the substrate.

9. The template according to claim 8, wherein the identification mark formed by engraving the lower surface of the substrate includes a vertical side surface and a flat bottom surface.

10. The template according to claim 6, wherein the identification mark is formed by coating the lower surface of the substrate with paint, and the paint has transparency which does not obstruct curing of a photocurable resin, with respect to a wavelength of irradiating light to be used in a step of curing the photocurable resin by step and flash imprint lithography.

11. A method of manufacturing a template with an identification mark, comprising:
forming a pattern formation template to be used in step and flash imprint lithography, the template including a main pattern region where a desired pattern is formed as a convex/concave pattern on an upper surface of a light-transmitting substrate; and
forming an identification mark which makes the template identifiable, in a region of a lower surface of the substrate, which at least partially overlaps the main pattern region.

12. The method according to claim 11, further comprising processing the lower surface of the substrate with a laser in order to form the identification mark.

13. The method according to claim 12, further comprising forming a groove including a vertical side surface and a flat bottom surface in the lower surface of the substrate by the processing using the laser.

14. The method according to claim 11, further comprising selectively coating the lower surface of the substrate with paint having a light transmittance which does not obstruct curing of a photocurable resin, with respect to a wavelength of irradiating light to be used when curing the photocurable resin by step and flash imprint lithography, in order to form the identification mark.

15. The method according to claim 11, wherein the pattern formation template is formed by imprinting from a parent template manufactured by electron-beam lithography.

16. The method according to claim 11, further comprising placing the template on a processing stage having an opening smaller than the template, with the lower surface of the template facing down, and sealing a portion between a periphery of the lower surface of the template and a periphery of the opening of the processing stage with an O-ring.
